(19) United States
(12) Patent Application Publication
(10) Pub. No.: US 2008/0293565 A1
(43) Pub. Date: Nov. 27, 2008

(54) METAL IMPREGNATED ACTIVATED CARBONS AND METHOD OF MAKING SAME

(75) Inventor: Andrew James Warburton, Greater Manchester (GB)

Correspondence Address: COHEN & GRIGSBY, P.C., 625 LIBERTY AVENUE, PITTSBURGH, PA, 15222-3152, US

(73) Assignee: Calgon Carbon Corporation, Pittsburgh, PA (US)

(21) Appl. No.: 12/126,139

(22) Filed: May 23, 2008

Related U.S. Application Data
(60) Provisional application No. 60/939,895, filed on May 24, 2007.

(51) Int. Cl. B01J 20/02; C01B 31/08; B01J 20/22

(52) U.S. Cl. 502/401; 502/416

(57) ABSTRACT

An odor control product is disclosed comprising an activated carbon impregnated with a metal oxide and a salt, wherein the carbon has an activity high enough to compensate for the physical adsorption capacity used by the salt. Methods of making metal-impregnated activated carbon using water-soluble metal salts are provided without need for ammoniacal solvent media. An activated carbon base of higher activity than would be normally employed is impregnated with water-soluble metal salt. The impregnated carbon is impregnated with an aqueous alkaline solution and the resulting hydroxide decomposed to the metal oxide.

### CLAIM OF PRIORITY

This invention claims the benefit of U.S. Provisional Application No. 60/939,895, filed on May 24, 2007.

### BACKGROUND

Copper-impregnated activated carbon is used as the basis for many gas phase adsorption applications. Such applications include, for example, odor control, abatement of environmental pollution and protection of personnel by means of industrial or military respirators.

Odor control and environmental abatement carbons tend to be based on single component (copper) impregnants, whereas industrial and military respirators are based on multi-component metals in which the copper-based impregnant is the primary adsorbate. Indeed, so important was the development of the use of copper as an impregnant in the military respirator field that copper-based, impregnated carbon was especially designated as “whetlerite” after its procreators, J C Whetzel and E W Fuller. The general processes for the production of copper-impregnated carbons for military use were referred to as “whetlerization.”

Many applications use an ill-defined, complexed copper(II) oxide/hydroxide as the active species of choice primarily because such species are active towards oxidizable gases, such as hydrogen sulphide, and effective for the retention of acidic gases. Additionally, the complexed copper(II) oxide is water-insoluble which inhibits significant copper leach under high humidity conditions such as those resulting from adverse conditions in industrial operations, high atmospheric humidity or from the condensation of expired breath in a respirator. This insolubility, however, dictates that the complexed oxide has to be loaded from a suitable precursor that can be subsequently transformed into the required metal oxide.

A common method for the impregnation of complexed copper(II) oxide onto activated carbon involves the use of so-called basic copper carbonate that has a stoicheiometry corresponding to CuCO₃.Cu(OH)₂.nH₂O. Although this compound is also water insoluble, it is readily soluble in strong aqueous ammonia. Therefore, strong aqueous ammonia is frequently used as the primary solvent in the manufacture of copper-impregnated activated carbon. The basic copper carbonate, or its solvated and impregnated derivates, then undergoes thermal decomposition according to the following simplified equation:

CuCO₃.Cu(OH)₂.nH₂O→2CuO+CO₂+(n+1)H₂O

Such conventional preparations with strong aqueous ammonia normally carry a residue of ammonia. Even a small residue of ammonia can cause problems, particularly where the copper impregnated activated carbon is used as a part of a respirator. Effective removal of ammonia is particularly apposite for military carbons to avoid the physical distress that results from the user of a military respirator inhaling even small concentrations of ammonia.

With the use of strong aqueous ammonia solution, gaseous ammonia is released during the decomposition and drying stages of the process. This gas should not be released to the atmosphere and therefore requires the institution of an effective abatement process.

An alternative method for making copper-impregnated activated carbon is to precipitate hydrated copper(II) hydroxide onto activated charcoal by the action of hot alkali metal hydroxide on a slurry of copper(II) sulphate and charcoal. Such a treatment, however, tends to produce a lower quality product, which is less effective for odor removal and which contains much of the copper on the outside of the pellets or granules. Therefore it also tends to be excessively dusty.

Thus, there is a need for an odor removal product and a method of preparing carbon with enhanced performance, such as by impregnating carbon with copper(II) oxide, that does not rely on ammonia solvent. There is also a need for a high quality metal-impregnated, or otherwise enhanced, activated carbon capable of removing malodorous gases with at least as good of an adsorption capacity as metal-impregnated products prepared using ammonia as solvent. A further useful aspect would be a product having increased sulphur compound adsorption capacity in aerobic conditions and increased organic vapor/sulphur compound adsorption capacity. It is further desirable to have a method of making an enhanced activated carbon that is cost efficient, relatively easy and improves current health, safety and environmental implications for use in gas phase adsorption applications.

### SUMMARY OF INVENTION

In general embodiments of the present invention provide an odor removing product comprising a metal-impregnated activated carbon. The carbon product is impregnated with a metal oxide and a salt. In an embodiment, the product has a carbon activity level that is sufficient to remove odors and/or environmental concerns (such as sulphides, mercaptans and other sulphurous compounds) while also compensating for inclusion of the salt. Optionally, the odor removing product contains no detectable ammonia residue.

In various embodiments the invention is directed to a method for making metal-impregnated activated carbon that comprises the impregnation of an activated carbon base with a water-soluble metal salt followed by impregnation with an aqueous alkaline solution and decomposition of the resulting hydroxide within the pores of the activated carbon. The metal is any water-soluble metal(II) compound capable of undergoing alkaline hydrolysis and dehydration to give an insoluble oxide species. In an example, the metal is nickel or zinc. In yet another example, the metal comprises copper. This particular decomposition is partially shown by the following equations:

[Cu(H₂O)₆]²⁺+2OH⁻═Cu(OH)₂↓+6H₂O

Cu(OH)₂═CuO+H₂O

The copper oxide and resulting salt co-produced from this process are fixed on the dried carbon and the only vapor loss is water. The anticipated reduction in physical adsorption capacity resulting from the co-impregnant is nullified by either washing with water to remove the soluble salt or by the use of a more active carbon base, that is to say, one with a higher physical adsorption capacity—defined by such tests as the Iodine Number, Carbon Tetrachloride Number or the Butane Adsorption value.

In an example, the method comprises the steps of impregnating an activated carbon with a water-soluble copper salt; impregnating the copper-impregnated carbon with an aqueous alkaline solution, wherein the reaction results with a copper(II) hydroxide species; and heating the resulting copper(II) hydroxide species at a temperature sufficient to decompose the species within the pores of said impregnated carbon.

In various embodiments the invention is directed to an effective method provided for producing a low dust, high quality metal-impregnated or otherwise enhanced activated carbon product that avoids the use of ammonia-soluble, water-insoluble, basic copper carbonate and reduces manufacturing costs. According to other aspects, an embodiment of the invention provides a highly water-soluble copper salt for the precipitation of the active copper species precursor in the pores of the activated carbon, and the replacement of a higher activity base to compensate for the hindrance of the impregnated co-product. The inventive product and process further confer one or more of the following advantages: increased sulphur compound adsorption capacity in aerobic conditions and increased organic vapor/sulphur compound adsorption capacity; reduced cost of product manufacture; removal of ammonia from the process; only drying of the product is required and the scrubber system is obviated; improved health implications owing to reduced copper-based dust emissions on the plant; improved safety implications owing to the removal of ammonia solution and the use of sulphuric acid required for the abatement of the ammonia; improved environmental implications because there is no release of ammonia from the process to atmosphere; and/or there is a reduced chance of carbon ignition during heat treatment owing to the reduced processing temperature.

Other objects, features, aspects and advantages of the present invention will become better understood or apparent from the following description and appended claims of the invention.

### EXAMPLES OF EMBODIMENTS OF THE INVENTION

The starting carbon base is activated or reactivated carbon prepared from any carbonaceous precursor. In an example, the carbon base is prepared from coal or coconut shell-based raw materials. Preferably the carbon base is an activated carbon having a relatively high carbon tetrachloride capacity, or “CTC” activity, which is a measure of the activated carbon's activity. In an example, the CTC activity is in the range of about 40% to about 120%. Within this range, activity of the carbon base is selected in view of the end application such that it has a sufficiently high enough activity to nullify the reduction in physical adsorption capacity resulting from a co-impregnant salt. For example, the carbon base CTC activity is at least 5% higher, and preferably at least 30% higher or more, than the CTC activity used to prepare standard formulations in traditional processes. Optionally, the impregnated salt may be washed out thereby minimizing or eliminating the need for an increased activity to compensate for the otherwise loss in performance arising from the generation of the salt co-produced from the process. The carbon pores are of sufficient size micropores, mesopores, macropores to capture hydroxide.

In an example of an embodiment, a reduction in activity of the carbon resulting from the reaction between the metal(II) species and the alkaline solution is compensated for by using an activated carbon base with an increased activity, prior to the impregnation step. For example, CUCl₂ (aq)+2NaOH═Cu(OH)₂ (aq)+2NaCl where the NaCl is the co-impregnating species, which is inert but will take up sites on the carbon porous surface and hence reduce its activity.

In an example, the metal salt is a copper salt. Alternatively, other water soluble metals are used such as nickel or zinc. The metals are water soluble metal(II) compounds capable of undergoing alkaline hydrolysis followed by dehydration to give a water insoluble oxide that has activity towards the gases to be removed from the contaminated stream. A combination of the metals can also be used as an embodiment of the invention. The copper salt is selected based in part on water-solubility and co-products. Results of an analysis of several possible copper salts are summarized in Table 1 for examples.

TABLE 1
Selection of Copper Salt

| Copper Salt | Formula | Solubility | Co-Product |
|---|---|---|---|
| Basic | CuCO₃•Cu(OH)₂•nH₂O | Insoluble | None (counter ions |
| Carbonate | | | are decomposed |
| | | | during processing) |
| Sulphate | CuSO₄•5H₂O | Low | Alkali metal |
| | | Solubility | sulphate |
| Acetate | Cu(CH₃COO)₂•2H₂O | Low | Alkali metal acetate |
| | | Solubility | |
| Nitrate | Cu(NO₃)₂•3H₂O | Soluble | Alkali metal nitrate |
| | | | (potentially |
| | | | hazardous) |
| Chloride | CuCl₂•2H₂O | Soluble | Alkali metal |
| | | | chloride |

Basic copper carbonate is useful as a precursor to copper(II) oxide and has the advantage that no counter ion is generated (since the carbonate salt is decomposed during processing), but it lacks solubility in water and consequently requires addition of an ammonia solvent. The use of copper sulphate or copper acetate gives rise to benign co-products but the starting salts themselves are insufficiently soluble to generate the impregnant concentrations of copper normally required without resorting to multiple impregnations. Hydrated copper(II) nitrate, on the other hand, has a very high solubility but the co-product in this case is an alkali metal nitrate which can be a powerful oxidizing agent in the presence of carbon and any precipitated sulphur. Even in situations in which the impregnated, activated carbon is employed only at relatively low or ambient temperature, such as in a respirator, there is a tendency for the nitrate ion to be reduced to gaseous nitrogen oxides. Hence, the practical salt used for most of the sulphur removal applications was hydrated copper(II) chloride. The following equation is a good representation:

CuCl₂.2 H₂O (aq)+2 NaOH (aq)═Cu(OH)₂↓+2NaCl (aq)+2H₂O Cu(OH)₂═CuO+H₂O

In some circumstances, it may be desirable to use solutions of the less soluble sulphate or acetate salts of copper as the starting material. For example, low impregnant concentrations of copper may be desirable for certain applications. In another embodiment of the invention, a high concentration of copper is preferred to give the carbon a long time before breakthrough of hydrogen cyanide, such as in military respirators for example, and such concentrations may be achievable from salts of lesser solubility. For example, for the removal of hydrogen cyanide from tobacco smoke only a low concentration of copper is necessary for the small concentration of hydrogen cyanide. In an embodiment of the invention, the low loading of copper then gives the product a higher CTC activity and allows for better adsorption of organics. Also, copper(II) chloride is more corrosive towards certain metals than is copper(II) sulphate, for example, and the avoidance of such corrosion may be desirable.

The aqueous alkaline solution includes any solution that can be classified as alkaline (i.e. that can give rise to hydroxyl ions) especially Group I metal hydroxides, such as Li, Na, K, Rb and Cs, and, optionally, Group II metal hydroxides—Be, Mg, Ca, Sr and Ba. For example, the alkaline solution is sodium hydroxide, potassium hydroxide, or calcium hydroxide.

While copper is generally the element of choice, other metal compounds may be used, such as nickel or zinc. For example, it is known that basic nickel(II) carbonate is insoluble in water and yet soluble in ammonia. Similarly, zinc carbonate is water insoluble and yet soluble in ammonium salt solutions. Thermal decomposition of such impregnated carbonates proceeds to generate oxide-based species that can be employed for odor abatement and personal protection. Such ammonia-soluble, carbonate species appear to be confined to those metals and oxidation states that are capable of generating ammoniated complexes of sufficient solubility to enable the impregnation of the activated carbon. Metals in the 2+ oxidation state are the most suitable candidates since those in oxidation states>2+ tend not to form stable carbonates owing to their intrinsic acidity and are more prone to ammonolysis rather than ammoniation.

In an embodiment, precipitation of such metal hydroxides onto activated carbon from aqueous solutions of soluble metal salts with alkaline hydroxide, followed by the thermal decomposition within the pores of the carbon may be similarly accomplished by the described methods.

### Example 1

In examples of embodiments of the present invention, single component (copper-only) impregnants on activated carbon were made using copper(II) chloride and an alkaline solution. The copper-impregnated activated carbon was then tested for hydrogen sulphide and sulphur dioxide removal.

In an example, 145 g hydrated copper(II) chloride was dissolved into 230 cm³ water. This solution was then impregnated onto the activated carbon having 1 kg of high activity coal base. An aqueous alkaline solution was then prepared by dissolving 69 g sodium hydroxide into 230 cm³ water. The resulting solution was impregnated onto the already copper-impregnated carbon. The resulting composite mixture was then dried at temperatures up to 150° C.

The resulting composite was then tested for hydrogen sulphide removal. A 160 cm³ sample of hydrogen sulphide was vacuum-packed into a glass cylindrical tube with an internal diameter of 3.0 cm and then pre-humidified to 10% moisture. A flow of 2 litres/minute of air was passed through the sample bed at virtual atmospheric pressure and 20° C. and containing 36 mg/litre of hydrogen sulphide and about 50% (ambient) or 90% (high) relative humidity. Air flow having these characteristics was passed through several hydrogen sulphide sample beds. Each sample bed was prepared as above. A hydrogen sulphide sensing electrochemical cell was used to detect the breakthrough of hydrogen sulphide. The time to a breakthrough of 20 ppmv hydrogen sulphide (a standard concentration) was recorded for each sample. The calculated hydrogen sulphide adsorption capacity of each sample was calculated from the information obtained from the experiments.

This procedure was repeated to determine the capacity for sulphur dioxide removal. The sulphur dioxide test used an inlet concentration of 45 mg/litre sulphur dioxide in place of the hydrogen sulphide and a sulphur dioxide sensing electrochemical cell.

A saturated sample from the inlet end of the tube was taken at the end of each experiment. The sample was analysed for total sulphur content by means of the gravimetric ESCHKA method. The saturation hydrogen sulphide (or sulphur dioxide) adsorption capacity of each sample was calculated from the information obtained from the experiments.

The basic formula comparing product prepared according to an example of the present invention with that of a standard copper(II) chloride-impregnated product is given in Table 2. The resulting physicochemical properties for each of the two formulations are illustrated in Table 3.

TABLE 2
Formulary of Standard and New Odor Removal Products

| Material | Standard 3 mm Pellets | New Product |
|---|---|---|
| Carbon Base | Coal (56% CTC) | High Activity Coal |
| | | (98% CTC) |
| Copper Salt | Basic copper carbonate | Hydrated copper(II) |
| | | chloride |
| Additives | Ammonium carbonate | Sodium hydroxide |
| | | solution |
| Solvent | Ammonia (0.880) | N/A |
| Diluent | Water | N/A |

TABLE 3
Physicochemical Properties of Standard and New Products

| Test Parameter | Standard 3 mm Pellets | New Product |
|---|---|---|
| Moisture (%) | Nil | Nil |
| Density (g/ml) | 0.57 | 0.48 |
| CTC (%) | 50 | 80 |
| Copper (%) | 4.86 | 4.66 |
| pH | 8.8 | 9.4 |
| A.P.D. (mm) | 3.1 | 3.1 |
| Ignition Temp/° C. | 274 | 256 |

The product removal capabilities obtained from tests using hydrogen sulphide or sulphur dioxide, under two conditions of relative humidity (“RH”), are detailed in Table 4 below.

TABLE 4
Adsorption Capacities of New and Standard Products

| | Adsorption Capacities/% w/w | | | |
|---|---|---|---|---|
| | At Breakthrough | | At Saturation | |
| | Standard | | Standard | |
| | 3 mm | New 3 mm | 3 mm | New 3 mm |
| Test | Pellets | Pellets | Pellets | Pellets |
| Hydrogen | 14.2 | 21.5 | 43.5 | 46.2 |
| sulphide in air at | | | | |
| ambient RH | | | | |
| Hydrogen | 12.5 | 21.8 | 43.2 | 49.9 |
| sulphide in air at | | | | |
| high RH | | | | |
| Sulphur dioxide | 5.4 | 7.7 | 14.6 | 22.8 |
| in air at ambient | | | | |
| RH | | | | |
| Sulphur dioxide | 5.2 | 7.1 | 16.8 | 24.6 |
| in air at high RH | | | | |

### Example 2

Plant trials were performed using 4 mm base carbon to demonstrate the concept on the large 500 kg scale. In this example, standard 4 mm pellets of currently established manufactured material were compared with laboratory prepared and plant prepared 4 mm pellets prepared according to embodiments of the present invention. Two trials were conducted using similar products. The 4 mm pellets were prepared similarly to the 3 mm pellets used in Example 1, except for having a different physical size. The physicochemical parameters of the starting products are illustrated in Table 5.

TABLE 5
Physicochemical Properties of Standard, Laboratory Prepared
and Manufactured Products

| | | Laboratory | |
|---|---|---|---|
| | Standard | prepared 4 mm | Plant prepared |
| Test Parameter | 4 mm pellets | pellets | 4 mm pellets |
| Moisture (%) | 0.3 | Nil | 3.2 |
| Density (g/ml) | 0.57 | 0.48 | 0.52 |
| CTC (%) | 55 | 78 | 65 |
| Copper (%) | 4.29 | 4.13 | 5.22 |
| A.P.D. (mm) | 4.2 | 4.2 | 4.2 |

The comparative H₂S adsorption capacities measured under ambient humidity conditions during the plant trial are recorded in Table 6.

TABLE 6
Adsorption Capacities of Standard, Laboratory
Prepared and Manufactured Products

| | Adsorption Capacities |
|---|---|
| Product (4 mm Pellets) | At Breakthrough/% w/w |
| Standard Manufactured Product | 8.1 |
| Laboratory Prepared New Product | 12.5 |
| Manufactured New Product (Plant | 12.4 |
| Trial 1) | |
| Manufactured New Product (Plant | 11.9 |
| Trial 2) | |

In all cases, there was about a 50% improvement in the performance of the new product relative to the standard manufactured product.

### Example 3

In another comparative test, both standard and new odor removal 3 mm carbon pellets were prepared using a base carbon activated to a CTC value of 56%. Standard pellets were made using basic copper carbonate and a copper(II) oxide impregnated product was prepared. The new copper(II) oxide impregnated product was prepared from hydrated copper(II) nitrate and potassium hydroxide solutions using the same technique as in Example 1 on the same carbon base. After decomposition at nominal decomposition temperature, particularly 175° C., this resulted with products having the characteristics in Table 7.

TABLE 7
Physicochemical Properties of Standard and New Products

| | Standard | Alternative |
|---|---|---|
| Test Parameter | 3 mm Pellets | 3 mm Pellets |
| Moisture (%) | Nil | Nil |
| Density (g/cm³) as | 0.57 | 0.66 |
| received | | |
| CTC (%) | 50 | 41 |
| Cu (%) | 4.86 | 4.93 |
| A.P.D. (mm) | 3.1 | 3.1 |
| Average H₂S Adsorption | 13.2 | 9.8 |
| Capacity (% w/w)^{a} | | |

^{a}Recorded at ambient humidity

The presence of the potassium nitrate can be surmised in the reduced carbon activity as tested using CTC activity and increased density. When tested against hydrogen sulphide in air at ambient humidity, the new alternative product was shown to give 74% of the standard product's performance. The alternative product was then washed removing the soluble co-impregnant, potassium nitrate, and dried. The sample product was re-tested and shown to meet 95% of the standard product performance. This result is consistent with the product's new characteristics, as indicated below. Thus, with washing this embodiment provided a product that almost matched the standard product. This further demonstrated that the washing process is an alternative way of preparing the new product whilst still avoiding ammonia.

TABLE 8
Physicochemical Properties of Standard and New
Products after Water Washing

| | Standard | Alternative |
|---|---|---|
| | 3 mm Pellets | 3 mm Pellets |
| Test Parameter | (post wash) | (post wash) |
| Moisture (%) | Nil | nil |
| Density (g/cm³) as received | 0.57 | 0.58 |
| CTC (%) | 51 | 48 |
| Cu (%) | 4.75 | 4.70 |
| A.P.D. (mm) | 3.1 | 3.1 |
| Average H₂S Adsorption | 13.1 | 12.4 |
| Capacity (% w/w)^{a} | | |

^{a}Recorded at ambient humidity

### Example 4

In another example, the base activated carbon extruded pellets used in Example 3 were further activated to a CTC value of 68%. Hydrated copper(II) nitrate solution was added to the activated carbon followed by a stoicheiometric equivalent of potassium hydroxide. The resulting material was then dried and decomposed at 175° C. to give a composition containing 6.2% copper. The base carbon (56% CTC), prior to the further activation, was treated and impregnated similarly to enable comparison of the two different activity carbon bases. The results are set forth in Table 9.

TABLE 9
Comparison of Physicochemical Characteristics and
Hydrogen Sulphide Adsorption Capacities on Products
with Higher and Lower Activity Bases

Alternative
3 mm Pellets

| | Higher Activity | Lower |
|---|---|---|
| Test Parameter | Base | Activity Base |
| Moisture (%) | 0.1 | Nil |
| Density (g/cm³) as received | 0.63 | 0.68 |
| CTC (%) base | 68 | 56 |
| Cu (%) | 6.24 | 6.42 |
| A.P.D. (mm) | 3.0 | 3.0 |
| Average H₂S Adsorption | 10.1 | 6.9 |
| Capacity (% w/w)^{a} | | |

^{a}Recorded at ambient humidity

### Example 5

In a further example of the present invention, a zinc-impregnated activated carbon was prepared and tested for hydrogen sulphide and sulphur dioxide removal from airstreams under high or ambient relative humidity conditions.

In this example, 113 g of zinc chloride was dissolved into 230 cm³ water. This solution was then impregnated onto the activated carbon (1 kg) of high activity (98% CTC) coal base 3 mm pellets. Sodium hydroxide (66 g) was dissolved into 230 cm³ water and the resulting solution was then impregnated onto the already zinc-impregnated carbon. The resulting composite mixture was then dried at temperatures up to 150° C. and a cooled sample was tested for its hydrogen sulphide adsorption capacity.

Each sample (160 cm³) was vacuum-packed into a glass cylindrical tube with an internal diameter of 3.0 cm and then pre-humidified to 10% moisture. A flow of 2 litres/minute of air, at virtual atmospheric pressure and 20° C. and containing 36 mg/litre of hydrogen sulphide and ca. 50% (ambient) or 90% (high) relative humidity was passed through each sample bed. The breakthrough of hydrogen sulphide was detected with a hydrogen sulphide sensing electrochemical cell. The time to a breakthrough of 20 ppmv hydrogen sulphide was recorded for each sample. The calculated hydrogen sulphide adsorption capacity of each sample was calculated from the information obtained from the experiments.

This procedure was repeated for testing against sulphur dioxide with an inlet concentration of 45 mg/litre sulphur dioxide in place of the hydrogen sulphide and employing a sulphur dioxide sensing electrochemical cell.

A saturated sample from the inlet end of the tube was taken at the end of each experiment. The sample was analysed for total sulphur content by means of the gravimetric ESCHKA method. The saturation hydrogen sulphide (or sulphur dioxide) adsorption capacity of each sample was calculated from the information obtained from the experiments.

TABLE 10
Physicochemical Properties

| | Zinc-impregnated |
|---|---|
| Test Parameter | Product |
| Moisture (%) | 0.1 |
| Density (g/ml) | 0.47 |
| CTC (%) | 81 |
| Zinc (%) | 5.22 |
| pH | 7.4 |
| A.P.D. (mm) | 3.1 |
| Ignition Temp/° C. | 295 |

The test results obtained using hydrogen sulphide or sulphur dioxide, under the stated conditions of relative humidity, are detailed in Table 11 below.

TABLE 11
Adsorption Capacities of Zinc-impregnated Product

Adsorption Capacities/% w/w

| Test | At Breakthrough | At Saturation |
|---|---|---|
| Hydrogen sulphide in | 7.3 | 15.8 |
| air at ambient RH | | |
| Hydrogen sulphide in | 7.6 | 16.9 |
| air at high RH | | |
| Sulphur dioxide in air | 3.1 | 13.7 |
| at ambient RH | | |
| Sulphur dioxide in air | 3.4 | 15.0 |
| at high RH | | |

### Example 6

In a further example of the present invention, a nickel-impregnated activated carbon was prepared and tested for hydrogen sulphide and sulphur dioxide removal from airstreams under ambient relative humidity conditions.

In this example, 220 g of nickel chloride hexahydrate was dissolved into 200 cm³ water. This solution was then impregnated onto the activated carbon (1 kg) of high activity (98% CTC) coal base 3 mm pellets. Sodium hydroxide (74 g) was dissolved into 200 cm³ water and the resulting solution was then impregnated onto the already nickel-impregnated carbon. The resulting composite mixture was then dried at temperatures up to 150° C. and a cooled sample was tested for its hydrogen sulphide adsorption capacity.

Each sample (160 cm³) was vacuum-packed into a glass cylindrical tube with an internal diameter of 3.0 cm and then pre-humidified to 10% moisture. A flow of 2 litres/minute of air, at virtual atmospheric pressure and 20° C. and containing 36 mg/litre of hydrogen sulphide and ca. 50% (ambient) relative humidity was passed through each sample bed. The breakthrough of hydrogen sulphide was detected with a hydrogen sulphide sensing electrochemical cell. The time to a breakthrough of 20 ppmv hydrogen sulphide was recorded for each sample. The calculated hydrogen sulphide adsorption capacity of each sample was calculated from the information obtained from the experiments.

This procedure was repeated for testing against sulphur dioxide with an inlet concentration of 45 mg/litre sulphur dioxide in place of the hydrogen sulphide and employing a sulphur dioxide sensing electrochemical cell.

A saturated sample from the inlet end of the tube was taken at the end of each experiment. The sample was analysed for total sulphur content by means of the gravimetric ESCHKA method. The saturation hydrogen sulphide (or sulphur dioxide) adsorption capacity of each sample was calculated from the information obtained from the experiments.

TABLE 12
Physicochemical Properties

| Test Parameter | Nickel-Impregnated Product |
|---|---|
| Moisture (%) | 0.1 |
| Density (g/ml) | 0.48 |
| CTC (%) | 79 |
| Nickel (%) | 4.96 |
| pH | 7.8 |
| A.P.D. (mm) | 3.1 |
| Ignition Temp/° C. | 390 |

The test results obtained using hydrogen sulphide or sulphur dioxide, under the stated conditions of relative humidity (“RH”), are detailed in Table 13 below.

TABLE 13
Adsorption Capacities of Nickel-impregnated Product

Adsorption Capacities/% w/w

| Test | At Breakthrough | At Saturation |
|---|---|---|
| Hydrogen sulphide in | 12.0 | 19.3 |
| air at ambient RH | | |
| Sulphur dioxide in air | 4.9 | 14.0 |
| at ambient RH | | |

### Example 7

In another example, no metal was used. A sodium hydroxide impregnated activated carbon was prepared and tested for hydrogen sulphide and sulphur dioxide removal from airstreams under high or ambient relative humidity conditions and additional tests were performed for the removal of hydrogen sulphide from nitrogen streams under high or zero relative humidity.

In this example, a solution of sodium hydroxide (69 g) in water (460 cm³) was added to the aforementioned activated carbon (1 kg) and the resulting mixture was dried at temperatures up to 150° C. Each sample (160 cm³) was tested as previously described in Example 5. The properties are show in Table 14.

TABLE 14
Physicochemical Properties

| Test Parameter | NaOH-impregnated Product |
|---|---|
| Moisture (%) | 0 |
| Density (g/ml) | 0.44 |
| CTC (%) | 85 |
| NaOH (%) | 5.90 |
| pH | 10.5 |
| A.P.D. (mm) | 3.1 |
| Ignition Temp/° C. | 273 |

Test results obtained using hydrogen sulphide or sulphur dioxide, under the stated conditions of relative humidity, are detailed in Table 15.

TABLE 15
Adsorption Capacities of NaOH-impregnated Product

Adsorption Capacities/% w/w

| Test | At Breakthrough | At Saturation |
|---|---|---|
| Hydrogen sulphide in | 14.6 | 25.6 |
| air at ambient RH | | |
| Hydrogen sulphide in | 16.3 | 28.8 |
| air at high RH | | |
| Sulphur dioxide in air | 5.2 | 14.5 |
| at ambient RH | | |
| Sulphur dioxide in air | 6.0 | 16.5 |
| at high RH | | |

While presently preferred embodiments of the invention have been shown and described, it is to be understood that the detailed embodiments and Figures are presented for elucidation and not limitation. The invention may be otherwise varied, modified or changed within the scope of the invention as defined in the appended claims.

What is claimed is:

1. A method for making metal-impregnated activated carbon for use in controlling or abating odor or other pollution, said method comprising the steps of:
a. impregnating an activated carbon with a metal species, wherein said species is any water-soluble metal(II) compound capable of being precipitated with an aqueous alkaline solution and decomposing to give a corresponding metal oxide;
b. impregnating said metal-impregnated carbon of step (a) with the aqueous alkaline solution, said reaction resulting with a metal(II) hydroxide species; and
c. heating the resulting metal(II) hydroxide species at a temperature sufficient to decompose the hydroxide species within the pores of the impregnated carbon of step (b).

2. The method of claim 1 wherein the activated carbon in step (a) has a carbon tetrachloride activity in the range of about 40% to about 120%.

3. The method of claim 1 further comprising a step (d) of washing said impregnated carbon with water.

4. The method of claim 1, wherein the metal species is selected from the group consisting of: copper(II) sulphate, copper(II) acetate, copper(II) nitrate, copper(II) chloride, zinc chloride and nickel chloride hexahydrate.

5. The method of claim 1, wherein the activated carbon of step (a) has a carbon tetrachloride activity sufficient to nullify the reduction in physical adsorption capacity resulting from the co-impregnant salt.

6. The method of claim 1, wherein the aqueous alkaline solution is a Group I metal hydroxide or a Group II metal hydroxide.

7. The method of claim 1, wherein the aqueous alkaline solution is sodium hydroxide, potassium hydroxide or other alkali metal hydroxide.

8. The method as set forth in claim 1, wherein the heating of step (c) is at least about 150 degrees centigrade.

9. The method of claim 1, wherein said impregnated activated carbon is prepared without the use of ammoniacal solvent media.

10. A method for making an odor removal product, comprising the steps of:
a. dissolving metal salt in solution;
b. impregnating an activated carbon with the metal salt;
c. impregnating the metal-impregnated carbon with an aqueous alkaline solution; and
d. drying the alkaline metal-impregnated carbon.

11. The method of claim 10 further comprising the step of:
e. washing the dried carbon to remove some of the alkaline solution.

12. The method of claim 10 further comprising the step of activating an activated carbon for use in step b.

13. The method of claim 10, wherein the metal salt is selected from the group consisting of: copper(II) sulphate, copper(II) acetate, copper(II) nitrate, copper(II) chloride, zinc chloride and nickel chloride hexahydrate.

14. The method of claim 10, wherein the aqueous alkaline solution is a Group I metal hydroxide or a Group II metal hydroxide.

15. The method of claim 10 wherein the odor removal product contains essentially no ammonia residue.

16. An odor removing product comprising an activated carbon impregnated with a metal oxide and salt, wherein the carbon has a carbon tetrachloride activity high enough to compensate for the physical adsorption capacity used by the salt.

17. The product of claim 16, wherein the metal is copper, nickel or salt.

18. The product of claim 16, wherein said product contains at least one percent by weight metal and has pores adsorbed with metal oxide.

19. The product of claim 16, wherein said product has a carbon tetrachloride activity of about 45% to about 150%.

20. The product of claim 16 wherein the product contains essentially no ammonia residue.
